(19) United States
(12) Patent Application Publication
(10) Pub. No.: US 2008/0204471 A1
(43) Pub. Date: Aug. 28, 2008

(54) SYSTEMS AND METHODS FOR IMPROVING IMAGE CLARITY AND IMAGE CONTENT COMPREHENSION

(76) Inventors: Brian J. Jaeger, Seattle, WA (US); Robert D. Nash, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 11/925,548

(22) Filed: Oct. 26, 2007

Related U.S. Application Data
(60) Provisional application No. 60/863,330, filed on Oct. 27, 2006.

(51) Int. Cl. G09G 5/02

(52) U.S. Cl. 345/594; 345/589

(57) ABSTRACT

A system and method employing a software-coloring tool designed to automatically display specified background color tints to all documents and windows displaying white backgrounds on any image display unit including but not limited to desktop, laptop, tablet and handheld computers, televisions, telephones, and other handheld technology using a computer readable medium. The software-coloring tool is provided on computer readable medium or is downloadable from websites. A specific range of natural colors are provided as software-based image overlays in an easy-to-access selection process designed to provide users a reading environment that reduces stress and discomfort related to reading on image display units, particularly to those suffering headaches, stress and fatigue caused by or associated with Computer Vision Syndrome, Irlen Syndrome/Scotopic Sensitivity, or other visual impairments or discomfort. The software color wizard determines the optimal color for each individual. A “registration code” is purchased that enables users to unlock ComfortScreen™ stored on the computer readable medium or to activate the software from downloaded files.

### PRIORITY CLAIM

This application claims priority to U.S. Provisional Patent Application Ser. No. 60/863,330 filed Oct. 27, 2006. This application is herein incorporated by reference in its entirety as if fully set forth herein.

### COPYRIGHT NOTICE

This disclosure is protected under United States and International Copyright Laws.© 2006 ReadScape™ Inc. All Rights Reserved. A portion of the disclosure of this patent document contains material which is subject to copyright protection. The copyright owner has no objection to the facsimile reproduction by anyone of the patent document or the patent disclosure after formal publication by the USPTO, as it appears in the Patent and Trademark Office patent file or records, but otherwise reserves all copyright rights whatsoever.

### FIELD OF THE INVENTION

An embodiment of the invention relates generally to enhancing visual clarity and viewability of video displays.

### BACKGROUND OF THE INVENTION

It is estimated that over 145 million Americans work on computers. Of these, approximately 130 million suffer from computer monitor-based eyestrain. Computer monitor-based eyestrain is the number one office-related health complaint. Millions of people suffer from reading difficulties and/or perceptual processing disorders. Two of the most prominent disorders treated today are Computer Vision Syndrome (CVS) and Irlen Syndrome/Scotopic Sensitivity (IS/SS). One proven way to reduce the symptoms of CVS and/or IS/SS is to adjust the contrast between the background and the type characters. Software applications currently available allow selection of background tints by a user selection of pre-defined, fixed collection of tints in a color palette that may be adjusted within increments of the red, green, and blue primary colors. Users select a tint by pointer engagement with one of the tints in the palette. Unfortunately, the tints available for user selection are not optimal for many subsets of users having direct and/or indirect vision difficulties, as occurs for IS/SS that previously is mitigated by the wearing of Irlen™ tinted glasses or using Irlen™ tinted Overlays. The Irlen tinted overlays and lenses are two tools designed to help people with a variety of conditions, including dyslexia, Aspergers Syndrome and Autism related disorders. The Irlen filter overlay method had been found to lessen and in some cases eliminate sensory overload and physical symptoms associated with direct viewing of monitor light sources and visual misperceptions thereto.

Mandatory reading on computers has increased the need to address conditions like CVS and/or IS/SS. Computer monitors do not use reflective light, but instead present images and text illuminated from behind such that users staring at a monitor read into the light emitted through a computer monitor. Reading into the light causes a substantial proportion of monitor viewers with substantial reading discomfort.

There is a system and/or method needed for improving clarity and/or content comprehension of back lit illuminated images, particularly for those who suffer from headaches, watery eyes, reading difficulties, and/or other discomforts associated with, or created by CVS and/or IS/SS.

### SUMMARY OF THE INVENTION

A system and software method to improve visual clarity and/or viewer comprehension of content presented in a video display or optical projection that reduces visual fatigue and is configurable to mitigate the visual impairments for those viewers having vision and/or vision comprehension disorders.

### BRIEF DESCRIPTION OF THE DRAWINGS

Embodiments of the present invention are described in detail below with reference to the following drawings.

FIGS. 1A-C illustrate examples of text appearance to those having IS/SS;

FIGS. 2A-C illustrate examples of different background coloring achieved by “software overlays” to the background surrounding the text type according to an embodiment of the invention;

FIG. 3 is a screenshot of a docked icon located on the start tray an embodiment of the invention;

FIGS. 4A-C are screenshots illustrating profiles and profile setup. Users then follow screenshots illustrated in FIGS. 5A-D;

FIGS. 5A-D are screen shots of ComfortScreen™'s color wizard, a method to determine a mitigating color for application to an image background to lessen and/or eliminate visual impairments related to users staring into monitor illuminated images;

FIGS. 6A-B are screenshots illustrating ComfortScreen™ color palette and brightness settings;

FIG. 7 is a schematic illustration of a local system for procuring and/or using the software-coloring tool;

FIG. 8 is a schematic illustration of an Internet system for procuring and/or using the software-coloring tool;

FIG. 9 is a method for mitigating visual impairments related to direct viewing of monitor illuminated images; and

FIG. 10 is a portion of a screenshot having mouse pointer engageable icons for procuring and/or activating the software-coloring tool from web sources.

### DETAILED DESCRIPTION OF THE PARTICULAR EMBODIMENTS

Particular embodiments include a software-coloring tool alternative to monitor filter overlays for coloring the background surrounding page text with tints having effective color intensity and/or contrast that may eliminate or substantially lessen the effects of Computer Vision Syndrome(CVS), Irlen Syndrome/Scotopic Sensitivity (IS/SS) or other impairments manifested that manifest distortions of text appearing in images presented in Windows, Mac, Linux, web-based and/or other computer operating system platforms. The software-coloring tool provides a solution that quickly, automatically applies the appropriate digital “overlay” of natural colors for the individual on any written image where black print is set against white background. Alternate embodiments of the software tool include applying natural colors to written images where the text print is of non-black colors. The colors may vary in intensity, balance, and contrast in relation to the color of the text. The intensity of the background colors may be in geometric progression or a continuous gradient. The software-coloring tool is provided on computer readable mediums, CD-ROMs for example, or downloaded from web-based sources. The software tool offers a wizard covering general profile, inefficient reading issues, strain and/or fatigue when reading. The wizard includes “Amount of Improvement” exercises with “software overlays” instead of colored acetate filter overlays. Other particular embodiments include a system and method employing a software-coloring tool designed to automatically display specified background color tints to all documents and windows displaying white backgrounds on any image display unit including but not limited to desktop, laptop, tablet and/or handheld computers, televisions, telephones, and/or other handheld technology using a computer readable medium. The software-coloring tool is provided on computer readable medium and/or is downloadable from websites. A specific range of colors is provided in an easy-to-access selection process and is designed to provide users a reading environment that reduces stress and/or discomfort related to reading on image display units, particularly to those suffering headaches, stress and/or fatigue caused by or associated with CVS and/or IS/SS. The software color wizard determines the optimal color for each individual. A “registration code” is provided at purchase that enables users to unlock the software stored on the computer readable medium or to activate the software from downloaded files. A perceptual problem exists for a substantial proportion of the general population where this contrast creates moderate to severe reading difficulties. Irlen Syndrome/Scotopic Sensitivity (IS/SS) is the name for this condition that makes words run into each other, italic sentences appear where there is standard print, and/or shadows form behind letters. IS/SS is not dependant on visual acuity, occurring with equal frequency in people with perfect eye sight and/or those requiring corrective eye wear. IS/SS is a specific perceptual difficulty resulting from the intensity and/or duration of lighting that can lead to significant discrepancies between black/white contrasts (printed information on white background) and creates problems with reading, writing, spelling, and/or math computation. An estimated 13% of the general population and 50% of dyslexics suffer from IS/SS. Particular system and method embodiments described below changes the white background on any computer-displayed documents and/or optical projected images to a user preferred tint previously determined within a quick color wizard. The technology of the system and methods reduces the contrast between white backgrounds and black print. ComfortScreen™ allows users to simply enable the software to enjoy less stressful, more productive reading. These tools can help to reduce job related health issues such as eyestrain, fatigue, stress, and headaches. The result can be increased productivity, ability to concentrate, and/or improved job satisfaction. With their assigned “registration code”, users access ReadScape™ website and download ComfortScreen™ to any computer in the world.

The software embodiments offered by ReadScape™ (reading+landscape) provide users the ability to adjust tints and/or colors for comfortable and/or effective reading on computer monitors and/or visual display units of all sizes on which screenshots from multiple software applications are displayed, including Microsoft and/or Adobe products. Users can change the background color of “active windows” related to Microsoft products and/or non-Microsoft products, including Adobe PDF files, and/or other applications opened from the Internet. ComfortScreen™ software embodiments can provide solutions for those monitor-viewing users suffering with Computer Vision Syndrome (CVS), Irlen Syndrome/Scotopic Sensitivity (IS/SS), or other impairments to minimize the effects of these conditions while reading on computer monitors.

Embodiments provide for background color adjustments in video displays and/or projections that provide optimal contrast reduction to enhance reading and/or parsing improvement of content presented in display or projection images. Other particular embodiments include colors chosen by experienced visual therapists concerning related disabilities. Moreover, the background colors and tints are user-selected via a Color Wizard profile selection tool and a OneClick on/off feature using natural colors. Different work, study, or family environments may have different natural colors assigned to multiple users such that, for example, a right click presents a drop down list of users. The users are selected and a toggle like switch icon is changed to display the active background color in use for the particular user profile selected. The toggle like switch icon may be put in the off position in which the switch defaults to a white background.

Method and/or software designed to automatically display specified background color tints to all documents and/or windows displaying white backgrounds on any image display unit including but not limited to desktop, laptop, tablet and/or handheld computers, televisions, telephones, and/or other handheld technology. A specific range of colors is offered in an easy-to-access selection process to provide users a reading environment that reduces stress related to reading on image display units. Related health issues including eyestrain, fatigue, stress, and/or headaches related to IS/SS have been reduced or eliminated while wearing Irlen Tinted Lenses or using Irlen Tinted Overlays. The optimal color is specified through a simple-to-follow method for each individual. A “registration code” is purchased that enables users to download specified tints, determined by an interactive color wizard, that is tailored to improve parsing of the visual content in video or projected images by users, especially those susceptible to eyestrain, CVS and/or IS/SS.

Software embodiments enable users to enjoy less stressful, more productive reading. Tools within the software reduces job-related health issues such as eyestrain, fatigue, stress, and/or headaches. The result can be increased productivity, ability to concentrate, and/or improved job satisfaction. With their assigned “registration code”, users access ReadScape™'s website and download ComfortScreen™ software to any computer in the world.

Other embodiments allow the user to switch global configurations of their computer with a minimum of mouse pointer commands, or keyboard equivalents. For example, one or two mouse clicks. The embodiments are simple for computer novices and offers advanced features that cater to assistive technology specialists, occupational and physical therapists, and advanced users wishing to have simple control over their computer system's visual styles. The user-selected background colors apply across a broad spectrum of software products, including, but not limited to Microsoft Windows, Microsoft Office, HTML documents reformatted automatically via CSS sheets, and/or Adobe's pdf file format. The particular embodiments provide several useful characteristics:
i. The advantages of the color selection software include:
   1. Simplicity allowing 1 to 2 mouse clicks for operation
   2. Wide-ranging feature set, useful for users with vision impairment, CVS, IS/SS, dyslexia, and/or autism (Pemberton, A. 1999)

Applicability: No other assistive technology software in this class encompasses Windows, Office, Adobe PDF files and/or Internet Explorer (i.e., HTML reformatting functionality)
ii. Simplicity and Efficiency
   1. OneClick Toggle Mechanism; Users can toggle their global configurations related to all visual style elements exposed by the Windows API by simply left-clicking our docked icon. Comparing this to industry standard style selection tools (such as the built-in Windows Control Panel Display Applet), our application can transform a users desktop in one click as opposed to 10 clicks.

QuickPick Profile Selector: Pick a profile and make global changes to a system's user interface (or visual style themes) in just two clicks.
iii. Clinically-Based
   1. Accessibility: Via system tray icon, access is available by default. The program is configured to launch on system startup and remain in the user's toolbar while the system is on. Users can rely on a simple interface that is easily accessible via the docked icon in the system tray.
   2. ComfortScreen™'s Color Wizard: A step-by-step process, is useful in quickly gauging the user's response to different colors. For ComfortScreen™'s application, it takes a short time, approximately two minutes for the user's profile to be configured for use. Adjustments to the profile, as well as re-launching the wizard are easily accomplished via the ComfortScreen™ Control Panel.
   3. ComfortScreen™'s Custom Color Palette: a selection of specified colors chosen to span the state space of visually perceptible contrast reductions. These custom colors offer the greatest contrast reduction, reading and/or parsing improvement, work performance improvement, and are specifically included in lieu of offering every color possible in an attempt to guide the user (in conjunction with the color wizard) to an immediately useful background color.
iv. Functionally Powerful
   1. Compatibility: Our product is completely Windows compliant, .NET compliant, and Office compliant. By using .NET, ComfortScreen™ can be compatible with future Microsoft Windows releases (currently includes Vista compatibility) and/or future Microsoft Office products.
   2. HTML ready: The web is a large repository of data, with each page described in HTML format for use with web browsers such as Internet Explorer. The system allows the user to select colors that reduce contrast and/or facilitate easy parsing while browsing the web, rather than simply obeying the (non-user-centric) defined color schema for each website that is viewed.
      a. CSS Autogeneration: Our system overrides external web pages' style sheets so that textual backgrounds can be rendered using the client's preferred color. This may entail the generation of a CSS style sheet that instructs the browser on colors to use for each component in an HTML file. The software generates a custom CSS override file each time the user either toggles the software, or selects a new profile.
   3. Customizability: The software allows users to select custom colors, font colors, font sizes, and/or even screen resolution using one simple and easy-to-use dialog. This Profile Control Panel allows any user to quickly create new profiles, participate in a customized color assessment, pick a color on their own, switch profiles, and/or adjust font colors and sizes.

Particular embodiments include a method, a combination, and a software related product deliverable as a program of computer readable code. Its construction involved the existing intellectual property of ReadScape, Inc., including the contribution of the specifications for the color set, the software-aided color wizard (a process), and industry standard HCI engineering techniques to produce the software embodiments further subdivided into a QuickPick Profile selector, a OneClick on/off mechanism, and a core functionality exposed by the software application (in the “control panel”).

From schools to corporations, wherever humans interact with a computer, our product has application. The primary applications can be corporations, schools, hospitals, centers of eLearning, libraries, computer laboratories, and/or any public enterprise that involves reading or viewing a computer display.

With an emphasis on “simple-to-use”, particular embodiments of ComfortScreen™ provide solutions for people who work inefficiently with new tools. ComfortScreen™ eliminates the new tool inefficiency issue by streamlining the discovery process. The streamlined color wizard process provides faster connection between the click of the user's mouse and ComfortScreen™ adjusting the open windows. Switching between users, as unfolds between shifts in some industries whose personnel use the same monitors, is a simple two-click process.

Alternate embodiments concern addressing the high contrast in computer monitors. As monitor technology advances, resolutions increase as does the contrast ratio. Most companies view this as a feature, and much research is done to improve perceivable brightness for each new monitor or cathode ray tube designed today. Many individuals report that a decrease in contrast relative to the fonts and backgrounds of computer displays assists in their ability to parse and/or assimilate textual or graphical data. Specifically, clients with IS/SS demonstrate significant improvement relative to reading comprehension when they employ Irlen's color filters over their text or monitor. This has the effect of reducing contrast by blending the color of the font or text with the color of the overlay (see Halliday, Resnick, and Walker: Fundamentals of Physics, 6^{th} ed. for a more complete description of these physical interactions involving light rays, reflection, refraction, total internal reflect, etc.).

Other embodiments include software executable code that presents the functional components in any combination of (1) a system tray icon, (2) a OneClick on/off toggle, (3) a QuickPick (two click) profile selector, (4) a color wizard based on a natural color model, (5) a WinShield PDF assister, (6) a CSS auto-generation that provides HTML functionality, (7) the use of window overlays that pass messages to an underlying windowing system, (8) using transparency and alpha blending to simulate actual physical overlays, substantially similar to WinShield offered by ReadScape™.

Other particular embodiments provide for the reduction in image contrast between the white background and black print commonly used on computer monitors. Contrast adjustment is made possible by applying a user specified tint to the displayed document. There are twenty tints from which to choose. Users can complete a quick wizard to determine which color provides the most comfort while reading on a computer monitor. When installed, the software can tint web pages, MS Office products, PDF files, and/or other documents that present white backgrounds.

START-UP
Once installed from the web-based store, the software opens at start-up.
Pinned to the start menu, turning the selected tint on/off is a simple, one mouse click, task.
It can also provide for preferences defined by multiple users.

Once purchased from the company website, ComfortScreen™ is downloaded onto their computer.

Windows:
Software detects Word, Excel, Works, PDF, jpeg, etc. files as they open.
Tint applies to entire document.
Tint automatically applies as users add pages.

Tint is not present on printed documents.

Web Browser
As web browser opens, software detects areas with the absence of color background (detects the white) and applies the tint.
May be a different tint than what is chosen for monocolor font documents to accommodate contrast of color fonts on search engine pages. The following might be tinted with different colors, for example green or peach cream.

### College Humor

Everything that is funny on the Internet is right here. Funny pictures, funny videos, and many stooges goofing off.

www.collegehumor.com/-47k-Jul 18, 2006-

### Humor in the Yahoo! Directory

Find sites dedicated to all things funny, including jokes, comedy, quotes, and also humorous sites relating to animals, entertainment, and the bizarre. dir.yahoo.com/Entertainment/Humor/-22k-Cashed-Similar pages
Depending on the angle on which the computer monitor is viewed, the green font may be more visible in the cream tint below.

### Open Directory—Recreation: Humor

Arts: Comics (5350); Arts: Illustration: Cartoons (144); Arts: Performing Arts: Comedy (1366); News: Analysis and Opinion: Columnists: Humor (194) . . . dmoz.org/Recreation/Humor/-16k-

### About: Political Humor

The Web's leading source for political humor, providing a witty and irreverent look at bizarre antics inside, outside and below the Beltway. politicalhumor.about.com/-43k-

ReadScape™ Company Website Several buttons, each colored a separate color, provide Internet users the opportunity to test different tints while reading text on ReadScape™ website.

A page of print displays. Then tint “overlays” are manually applied. The first color covers the entire document. The process continues with the introduction of a new color.

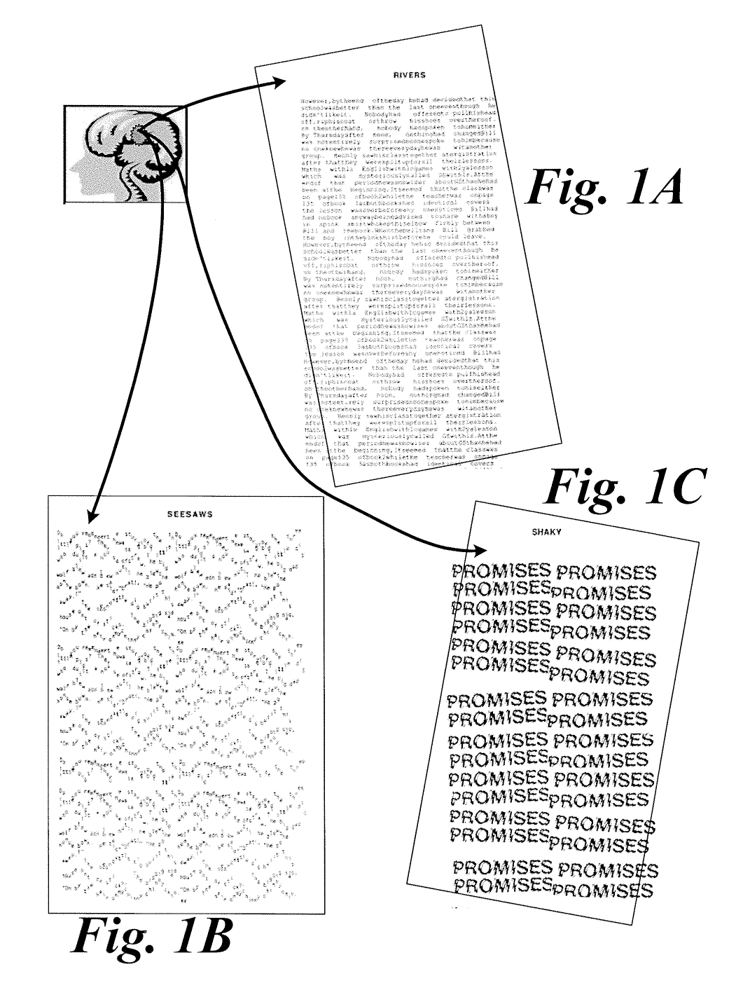

FIGS. 1A-C illustrate examples of text appearance to those having IS/SS. IS/SS is not entirely dependent on the eyes nor the occipital lobe. Research has pin-pointed the magno-parvo “message center” in the brain where dyslexia is likely to occur. This is the area where IS/SS is thought to occur as well. FIG. 1A illustrates a manifestation of IS/SS appearing as gaps in page text that appear as string-like clear areas or “rivers”.

FIG. 1B illustrates another manifestation of page text having an undulating or “seesaw” effect. FIG. 1C illustrates an IS/SS manifestation as moving or “shaky” text.

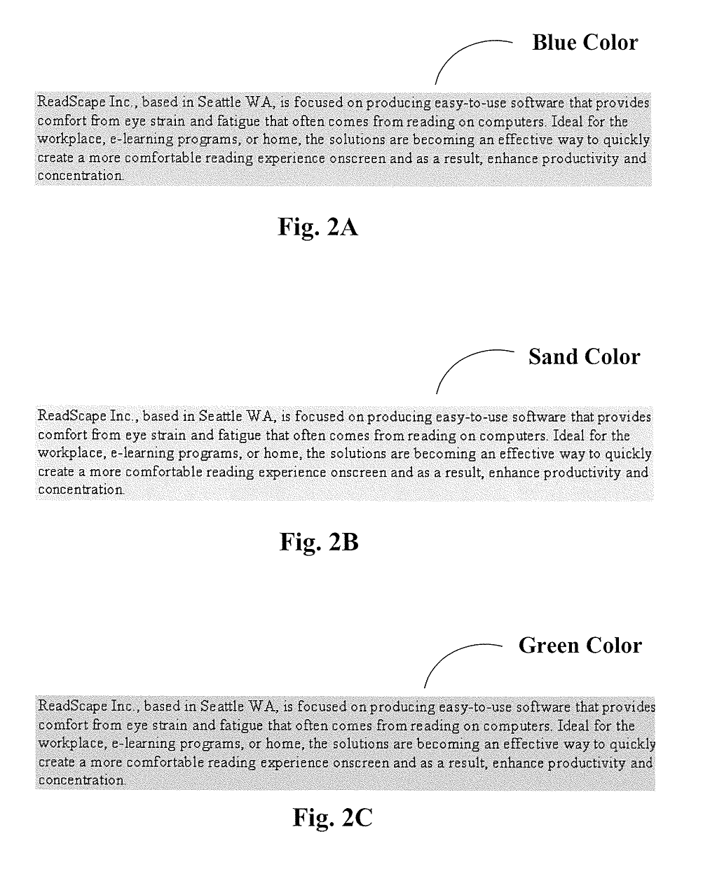

FIGS. 2A-C illustrate examples of different background coloring achieved by “software overlays” to the background surrounding the text type as a means to moderate or eliminate the effects of CVS, IS/SS and/or other visual impairments. FIG. 2A illustrates a blue tinted background, FIG. 2B a sand tinted background, and FIG. 2C illustrates a green tinted background to mitigate the eyestrain, CVS, IS/SS and/or other visual impairment manifestations.

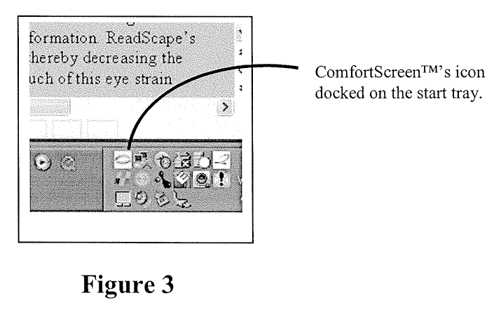

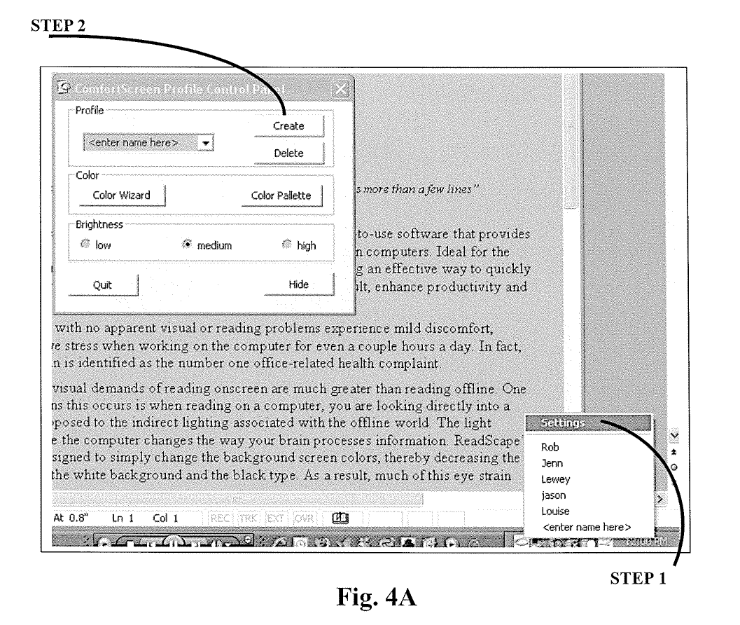

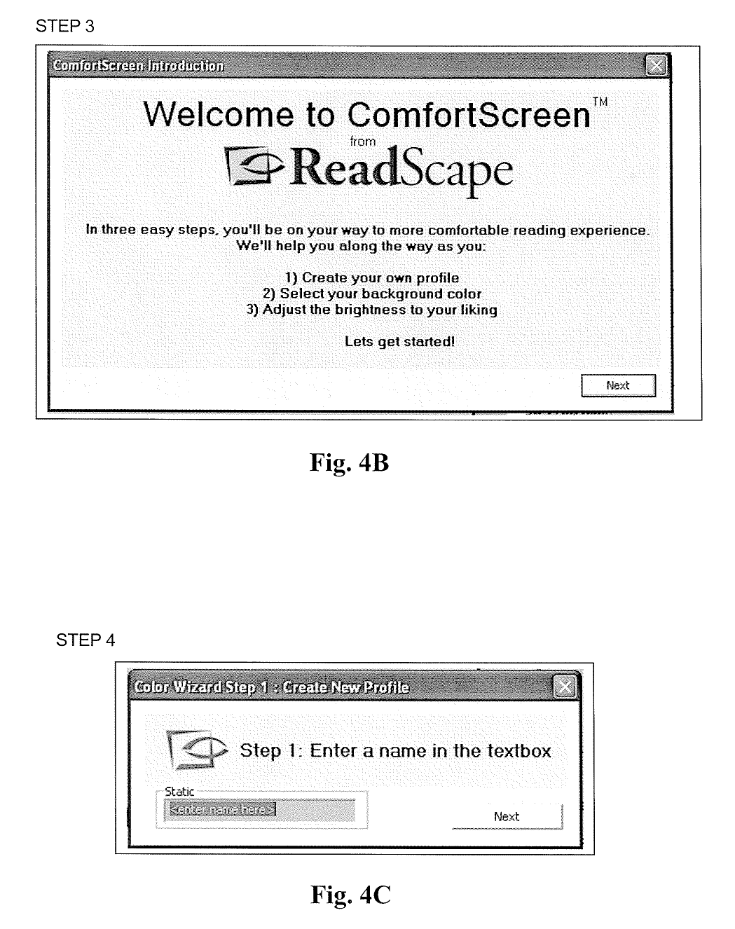

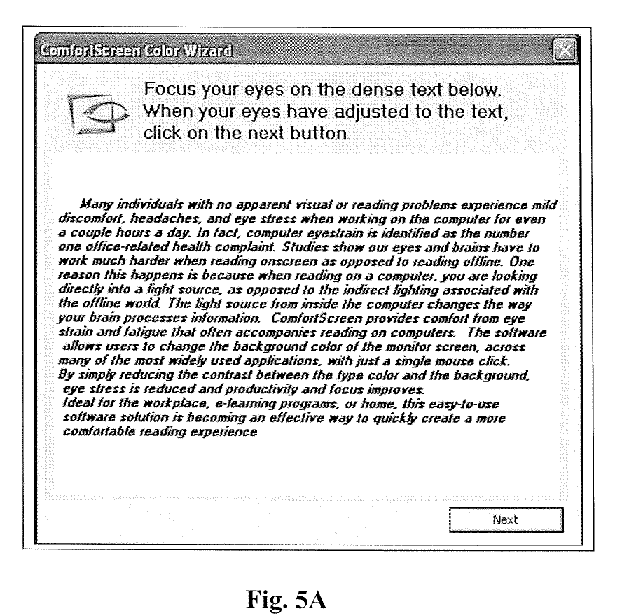

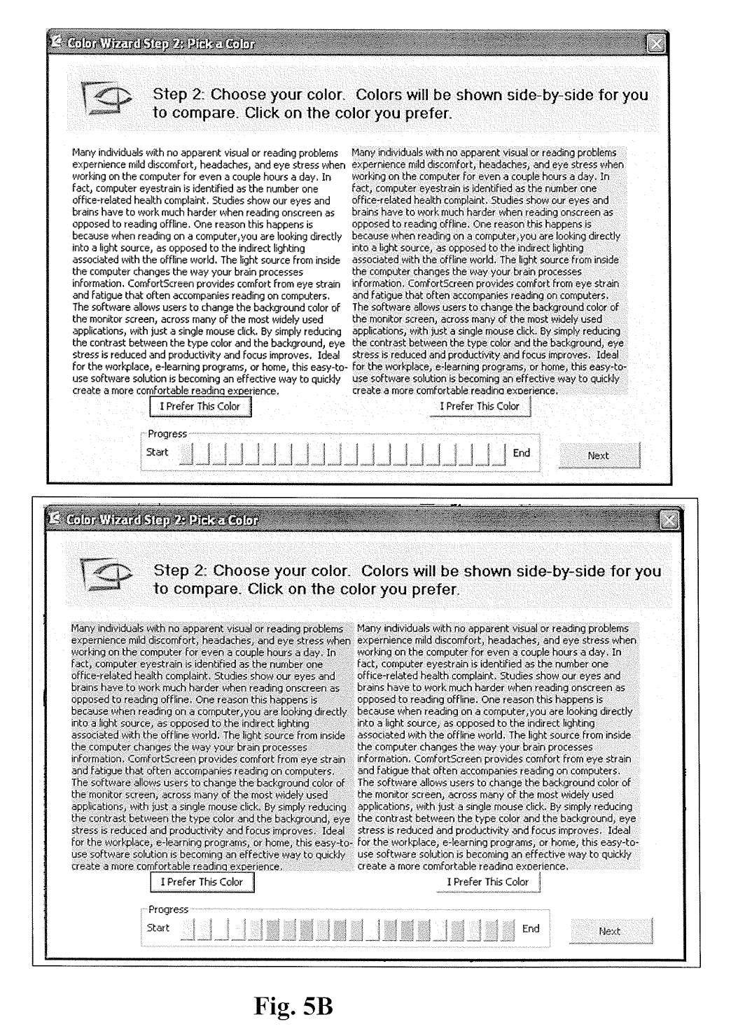

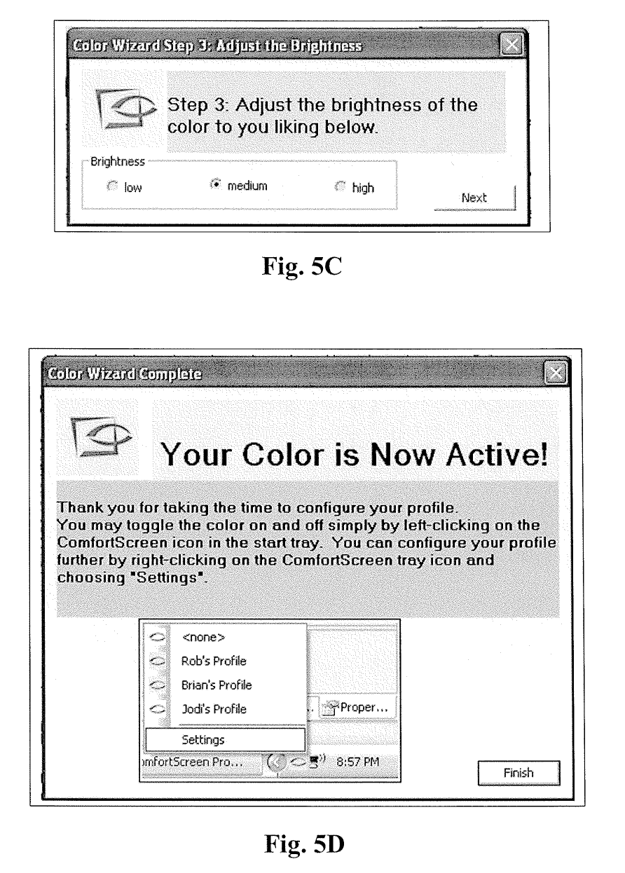

FIG. 3 is a screenshot of ComfortScreen™'s docked icon on the start tray. Users left click only once on the icon to turn software on/off; Users right click to reveal Profile Control Panel. FIGS. 4A-C are screenshots illustrating profiles and profile setup. Users right click on the docked icon, select Settings, and ComfortScreen™ Profile Control Panel is revealed (FIG. 4A). FIG. 4B is a screenshot defining the easy three step process. FIG. 4C is a screenshot illustrating where users enter their name. Users then follow screenshots illustrated in FIGS. 5A-D;

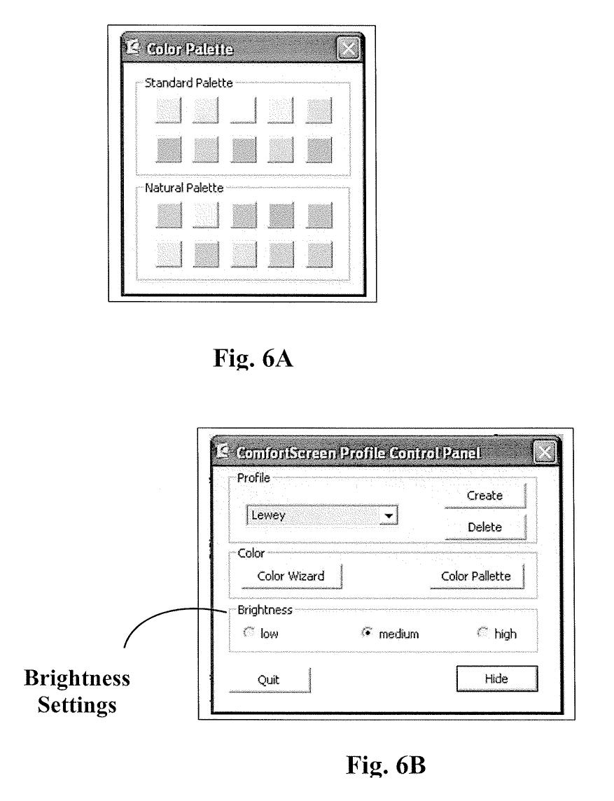

FIGS. 5A-D are screen shots of ComfortScreen™'s color wizard, a method to determine a mitigating color for application to an image background to lessen and/or eliminate visual impairments related to users staring into monitor illuminated images; FIG. 5A is a screenshot illustrating dense text set on a white background. FIG. 5B shows two screenshots. The top screenshot is the first screen from which users begin to compare and/or contrast different colored backgrounds. The bottom screenshot shows the final screen on which users complete the compare and/or contrast tasks. FIG. 5C is a screenshot illustrating the brightness settings of low, medium, and high. FIG. 5D is a screenhot illustrating an announcement that the selected color is now active, and illustrates where users can find ComfortScreen™ docked icon on the start tray. FIGS. 6A-B are screenshots illustrating ComfortScreen™ color palette and brightness settings;

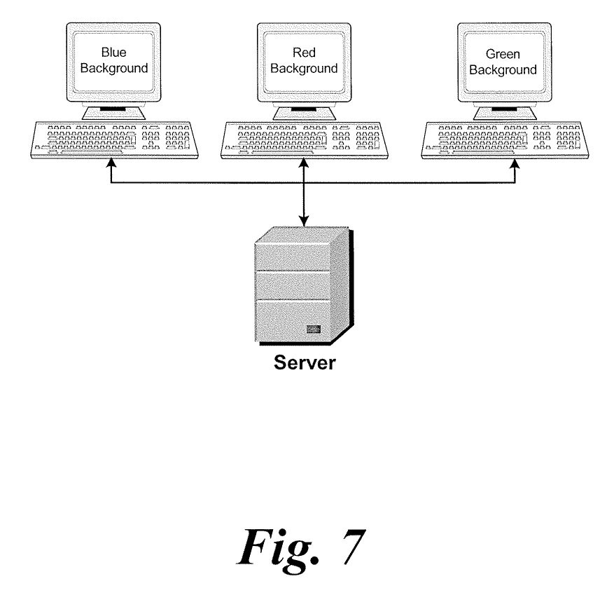

FIG. 7 is a schematic illustration of a local system for procuring and/or using the software-coloring tool. A local server provides the software-coloring tool to three local computer systems that are configured with different colors used by different users. In this case one monitor includes a blue background, another a red background, and another with a green background.

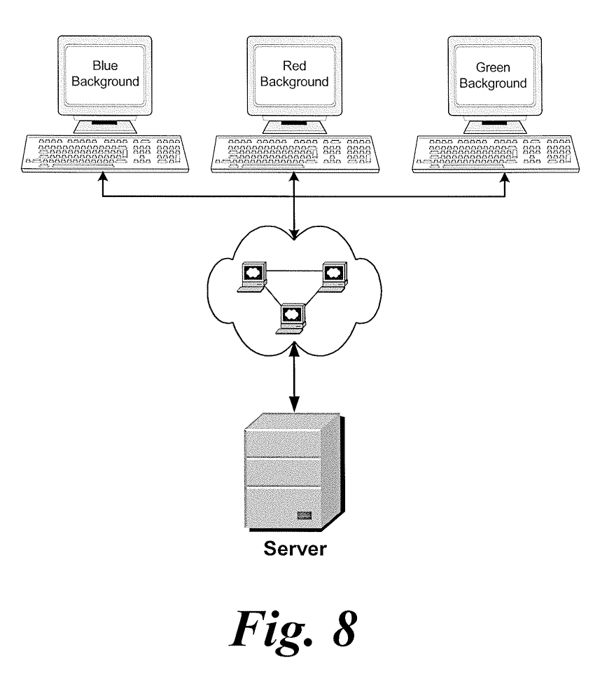

FIG. 8 is a schematic illustration of an Internet system for procuring and/or using the software-coloring tool. A server provides the software-coloring tool to three local computer systems via an Internet connection. The local computers are configured with different colors used by different users. In this case one monitor includes a blue background, another a red background, and another with a green background.

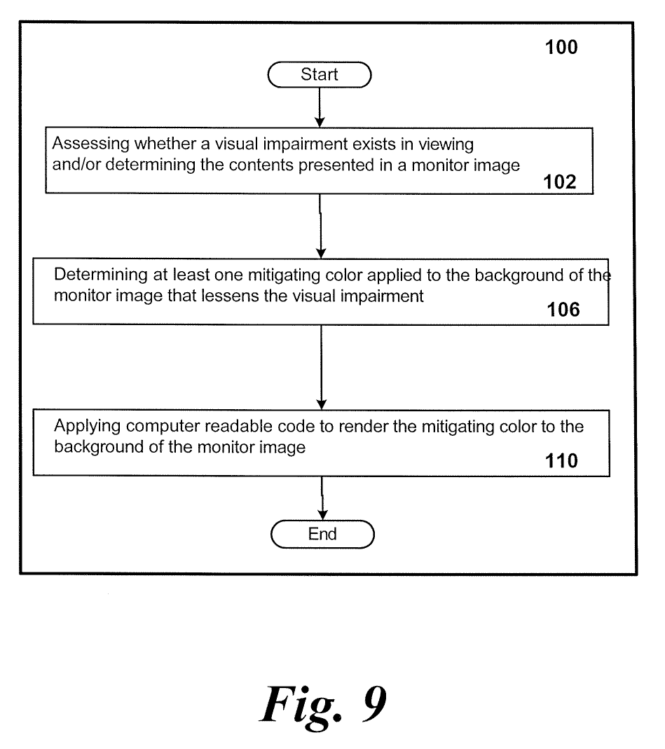

FIG. 9 is a method 100 for mitigating visual impairments related to direct viewing of monitor illuminated images. The method 100 begins with processing block 102 wherein a color wizard helps determine whether eyestrain exists in viewing and/or determining the contents presented in a monitor image. The method 100 concludes with processing block 110 in which computer readable code for the software-coloring tool is applied to render the mitigating color to the background of the monitor-illuminated images. An example of the computer readable code is found in the appendix.

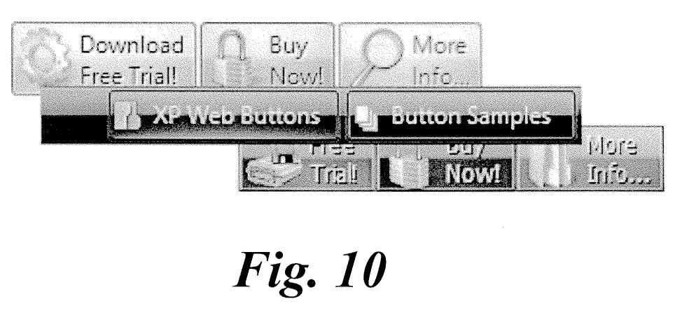

FIG. 10 is a portion of a screenshot having mouse pointer engageable icons for procuring and/or activating the software-coloring tool from web sources. A user has the option to download a free trial, to purchase directly, to get background samples, and/or to get passwords to unlock a free trial or activate a purchased copy. Pinned to the Start Menu with quick access, users could easily enable/disable the software, or have it on all the time.

While the particular embodiments have been illustrated and described, many changes can be made without departing from the spirit and scope of the invention. For example, the particular embodiments are not limited to video screens and/or optical projections, but may be applied to plasma TV screens, high density and/or high definition optical mirrors, a personal digital assistant (PDA), cell phone screens, and/or digital music player monitors. Accordingly, the scope of the invention is not limited by the disclosure of the preferred embodiment. Instead, the invention should be determined entirely by reference to the claims that follow.

We claim:

1. A method of adjusting the background color in a video display comprising:
assessing whether a visual impairment condition and/or reading discomfort exists of a user viewing monitor having a text message discernable from a surrounding background, and if the visual impairment condition and/or reading discomfort exists;
determining at least one mitigating color that lessens the visual impairment and/or discomfort; and applying computer readable code to render the mitigating color to the surrounding background.

2. The method of claim 1, wherein the mitigating color allows the user to discern italic from regular text in a direct viewing of a monitor light source.

3. The method of claim 1, wherein the mitigating color includes natural colors.

4. The method of claim 3, wherein the natural colors vary in intensity.

5. The method of claim 3, wherein the natural colors vary in contrast to color of the text message.

6. The method of claim 1, wherein assessing whether a visual impairment condition exists includes applying the software code to provide different colored regions to the background surrounding the text message.

7. The method of claim 1, wherein applying the computer readable code to render the mitigating color is accomplished by an icon having a switch character located on the video display.

8. The method of claim 1, wherein applying the computer readable code to render the mitigating color is adjustable to a plurality of users.

9. The method of claim 1, wherein applying the computer readable code to render the mitigating color simultaneously in “active windows” related to Microsoft products and/or non-Microsoft products, including PDF files, and/or other applications opened from the Internet.
